(19) United States
(12) Patent Application Publication
(10) Pub. No.: US 2010/0293476 A1
(43) Pub. Date: Nov. 18, 2010

(54) PEER BASED SOCIAL NETWORK DATING ENVIRONMENT

(75) Inventors: Helise Feld Rosenblum, Boca Raton, FL (US); Lissette Battista Rutledge, Coral Springs, FL (US); Todd St. Pierre, Pompano Beach, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Radius Dating LLC, Boca Raton, FL (US)

(21) Appl. No.: 12/779,453

(22) Filed: May 13, 2010

Related U.S. Application Data
(60) Provisional application No. 61/177,788, filed on May 13, 2009.

(51) Int. Cl. G06F 3/01; G06F 15/16

(52) U.S. Cl. 715/753

(57) ABSTRACT

A method and information processing system for operating a matching service is disclosed. One method includes displaying a first social network and a second social network associated with a user of an interactive environment. The first and second social networks include one or more members of the interactive environment that are linked to the user. A selection of at least a first member in the first social network and at least a second member in the second social network is received from the user. The first member and the second member are free from association with each other. A connection request to the first member and the second member are sent for linking the first member and the second member together in response to receiving the selection of the first member and the second member.

### CROSS-REFERENCE TO RELATED APPLICATIONS

This application is related to the inventors' U.S. Provisional application “Peer Based Social Network Dating Environment”, Application No. 61/177,788, filed on May 13, 2009. This related application is incorporated herein by reference in its entirety.

### FIELD OF THE INVENTION

The present invention generally relates to social networking environments, and more particularly relates to connecting individuals within a social networking dating environment based on the individuals' peers.

### BACKGROUND OF THE INVENTION

The popularity of online dating websites has greatly increased over the past years. Most online dating websites generally utilize user profiles to identify a potential match for a given user. Also, some of these websites also utilize a more scientific approach to identify potential matches where a user answers many questions similar to a personality test. This process can be very time consuming. With most conventional online dating websites, the user has to either rely on the website's suggestions or has to search through numerous profiles to identify someone of interest. This process can be very unreliable and unpredictable.

### SUMMARY OF THE INVENTION

In one embodiment, a method for operating a matching service is disclosed. The method comprises displaying a first social network associated with a user of an interactive environment. The first social network comprises one or more members of the interactive environment that are linked to the user. A selection by the user of at least a first member in the first social network is received. At least a second member in a second social network that is associated with the first member and is free from association with the user is displayed to the user in response to receiving the selection. A selection by the user of at the second member is received. A connection request to the second member on behalf of the user is sent in response to receiving the selection of the second member. The second member is added to the first social network in response to the second member accepting the connection request.

In another embodiment, a method for operating a matching service is disclosed. The method comprises displaying a first social network and a second social network associated with a user of an interactive environment. The first and second social networks comprise one or more members of the interactive environment that are linked to the user. A selection of at least a first member in the first social network and at least a second member in the second social network is received from the user. The first member and the second member are free from association with each other. A connection request to the first member and the second member are sent for linking the first member and the second member together in response to receiving the selection of the first member and the second member.

In yet another embodiment, an information processing system for operating a matching service is disclosed. The information processing system comprises a memory and a processor communicatively coupled to the memory. The information processing system also comprises an interactive environment communicatively coupled to the memory and processor. The interactive environment performs receiving, from at least one member in a first social network, a character recommendation, based on personal experience of trustworthiness or a personal interaction or personal judgment, or a rating scale associated with at least one member in a second social network. The rating reflects a quality of an interaction between the at least one member in a first social network and the at least one member in the second social network. The first social network and the second social network are displayed to the user of the interactive environment. The first and second social networks comprise one or more members of the interactive environment that are linked to the user. The displaying comprises organizing at least the one or more members in the second social network based on the rating associated therewith. The rating associated with each of the one or more members in the second social network is displayed to the user. An indication is received from the user that a set of information associated with at least one member in the one or more members is authentic. A profile associated with the at least one member is updated to indicate that the set of information has been verified by the user. A selection by the user of at least a first member in the first social network and at least a second member in the second social network is received. The first member and the second member are detached from each other in the interactive environment. The selection of the second member in the second social network is based on the rating associated therewith. A connection request is sent to the first member and the second member for linking the first member and the second member together in response to receiving the selection of the first member and the second member.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating an operating environment according to one embodiment of the present invention;

FIG. 2 illustrates one example of a user interface according to one embodiment of the present invention;

FIG. 3 illustrates another example of a user interface according to one embodiment of the present invention;

FIG. 4 is an operational flow chart illustrating one process of a user joining an interactive environment according to one embodiment of the present invention;

FIG. 5 is an operational flow chart illustrating one process of a user interacting with an interactive environment according to one embodiment of the present invention;

FIG. 6 is an operational flow chart illustrating one process of a user interacting with a mailbox option of an interactive environment according to one embodiment of the present invention;

FIG. 7 is an operational flow chart illustrating one process of a user interacting with a search option of an interactive environment according to one embodiment of the present invention;

FIG. 8 is an operational flow diagram illustrating one process of a user connecting two friends together using an interactive environment according to one embodiment of the present invention

FIG. 9 is a block diagram illustrating a more detailed view of an information processing system according to one embodiment of the present invention; and

FIG. 10 is a diagram illustrating a member progression graph for an interactive environment according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting;

but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Operating Environment

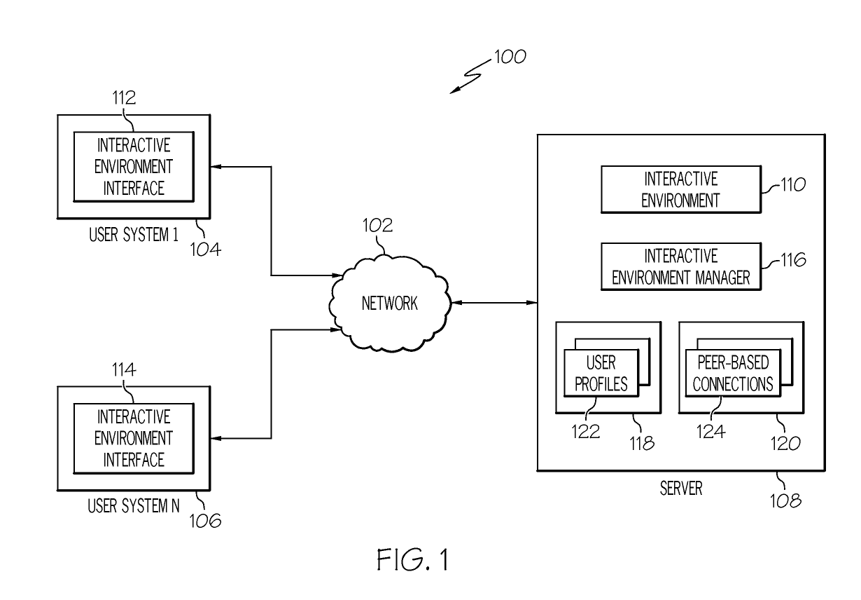

According to one embodiment, FIG. 1 illustrates one example of an operating environment/system 100 for a peer-based social network dating environment. In particular, FIG. 1 illustrates an environment 100 that provides a social network where an individual can be connected with another individual by a mutual peer or can connect with a friend of a mutual peer. For example, an individual can utilize the social network(s) of family, friends, and colleagues to find a significant other. Individuals are able to create a circle(s) of friends that spawn additional circle of friends. These individuals can then use these “circles” to search for a significant other. Stated differently, individuals are able to meet “a friend of a friend”. This is advantageous because connections are created through familiarity utilizing a social networking environment. An individual is no longer required to rely on potential match suggestions presented by the website and is no longer required to search through numerous profiles. The individual can be connected with another individual through a mutual friend. Therefore, the system 100 offers a matchmaking environment where users are able to “setup” other users with various individuals or where users can find someone of interest through a mutual peer.

FIG. 1 shows one or more networks 102 that, in one embodiment, are wide area networks, local area networks, wireless networks, and/or the like. In one embodiment, the system 100 includes a plurality of information processing systems 104, 106, 108 that are communicatively coupled to the network(s) 102. The information processing systems 104, 106, 108 include one or more user systems 104, 106 and one or more servers 108. The user systems 104, 106 can include information processing systems such as desktop computers, laptop computers, wireless devices (such as mobile phones, personal digital assistants, etc.), and the like.

The server system 108 includes an interactive environment 110 that users of the user systems 104, 106 interact with via a user web interface or interactive environment Interface (I/F) 112, 114. The interactive environment 110, in one embodiment, is a website, web application, a mashup, or the like where users can interact with other users in a social networking environment. For example, users can associate themselves with one or more users, thereby creating a social circle or network. A user can be associated with many social circles such as “work”, “school”, and “family” social circles. Members of a particular social circle can communicate with each other; post messages in the interactive environment 110 that other members can view; display pictures and/or video that the other members can view; send messages to the other members; transfer files to the other members, video conference, and the like. However, it should be noted that a user can also configure his/her account/information to be accessible to anyone (e.g., users outside of his/her social circle, guests using the interactive environment, etc.).

The server system 108 also includes an interactive environment manager 116 for managing user interaction with the interactive environment 110 and also for managing the display of information to a user. The server system 108 also includes one or more databases 118, 120 such as (but not limited to) a user profile database 118 and a peer-based connection database 120. It should be noted that a single database can be used as well. The user profile database 118, in one embodiment, includes user profiles 122 and the peer-based connection database 120 includes peer-based connection information 124.

User profiles 122 include information associated with each user of the interactive environment 110. For example, user profiles 122 can include information such as (but not limited to) user address information, user email information, username and password information, user preferences, social circle information, and the like. Peer-based connection information 124 includes information associated with peer-based connections. A “connection” refers to a process in which a user initiates communication, a virtual meeting, or the like between two or more other users. Therefore, this user is “connecting” two or more other users. In one embodiment, the users being connected are not within the same social circle of the interactive environment 110. However, in other embodiments, these users can be in the same social circles as well. In yet another embodiment, if this is the first time one of the users is being “connected” by a peer, a new social circle is automatically generated by the interactive environment manager 116 that includes all of the individuals that the user has been connected with.

In one embodiment, a user's profile 122 or at least a subset of information in the profile can be verified and displayed as such. For example, if a first user states in his/her profile that he/she is from Boca Raton, Fla. a second user who knows the first user can select a “verified” option in the interactive environment 110 that assigns a “verified” status to the first user's profile 122 or portion of the profile that has been verified. This “verified” status is displayed to other users of the interactive environment 110. This embodiments adds a level of security to the interactive environment 110.

Peer-based connection information 124 can, for example, be generated for a user who initiates a connection between two or more of his/her peers. Alternatively, peer-based connection information 124 can be generated for each user of a connection. For example, if User A initiates a connection for Users B and C, peer-based connection information 124 is not only generated for User A, who initiates the connection, but also for Users B and C as well. Also, a user can initiate a connection on his/her own. For example, a user can search/view other users that are “linked” or associated with a member of the user's social circle(s). The user can then send a connection request to these other users if desired. Peer-based connection information can include, for example, an ID associated with the user who initiated the connection; an ID associated with the two or more users that were connected; date/time information associated with the connection; status of the connection; and the like.

The status information of the connection can include various types of information. For example, status information can indicate whether one or more of the parties (e.g., User B and/or User C) has viewed the connection; accepted the connection; rejected the connection; has indicated interest in the connection; has responded to the connection (e.g., responded back to the initiating user and/or to the other connected user; and the like. The interactive environment 116 generates the peer-based connection information 124 to track and monitor peer-based connections. Peer-based connections are discussed in greater detail below.

Peer-Based Connections

As discussed above, users can initiate connection requests on behalf of other users or can initiate a connection request on his/her own. The following is a more detailed discussion of the interactive environment 110 and peer-based connections. Initially, a user joins the interactive environment 110 and enters personal information such as name, address, email, desired user name and password, and/or the like. The interactive environment manager 116 receives this information and establishes a user profile 122, as discussed above. The interactive environment manager 116 also determines if the requested user name is already in use and appropriately notifies/prompts the user.

Users can be sent invitations from other users to join the interactive environment 110. Therefore, the interactive environment manager 116 determines if the user was invited to join the interactive environment 110. If the user was invited, the interactive environment manager 116 links the new user with the user who has invited him/her. Each of these users is displayed in the other's social circle. For example, the interactive environment Interface 112, 114 can include an area where members of a user's social circle are displayed. The user can add additional information to his/her profile such as interests, background, dating interests, or any other type of information that the user would like to have displayed to other members of his/her social circle or to the public to find a significant other. The user can search for people who are already members of the interactive environment 110. If a user finds a friend or someone that they would like to have in their social circle the user can send a request to the person to be linked with the user. If the person accepts the request then the interactive environment manager 116 links the user and the person together in a social circle.

When the user logs into the interactive environment 100 via the interactive environment Interface 112, 114 various options are displayed to the user. For example, an account option can be displayed where the user can update/modify his/her account details. For example, the user can edit/delete information such as user information; add/delete pictures; set a default display image; and the like. It should be noted that, in one embodiment, that uploaded pictures need to be approved by the interactive environment 100 of interactive environment administrator. Another option is a “my friends” option that when selected shows the user all of his/her friends that have been linked to the user. A search option can also be displayed that allows that user to search the interactive environment 100 for information, people, and the like. A mailbox option can also be displayed to the user. The mailbox option allows a user to send receive messages to other users of the interactive environment 110. In one embodiment, a user can also send/view third-party email accounts as well. A user can also send/receive and respond to connection requests via the mailbox as well. However, it should be noted that a separate area of the interactive environment Interface 112, 114 can be reserved for displaying connection request information as well.

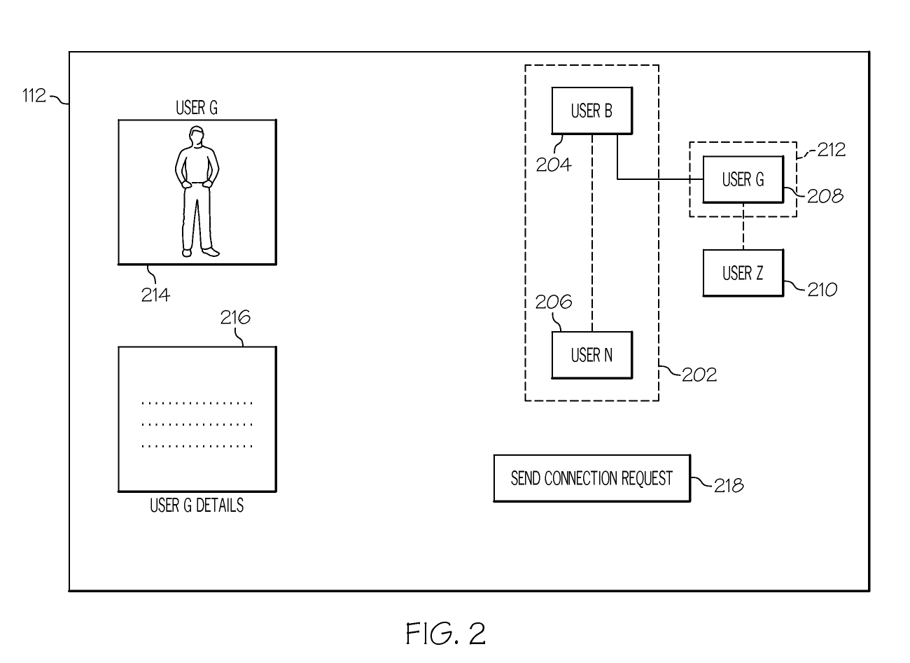

Once the user has joined the interactive environment 110, the user can begin to receive, send, and/or initiate connection requests. For example, FIG. 2 shows one example of an interactive environment Interface 112 for sending a connection request. In particular, FIG. 2 shows that the interactive environment Interface 112 displays the user's social circle 202 and its members 204, 206. The user is able to select one or more of the members 204, 206 and be presented with a list of users that are linked to the selected member 204. For example, FIG. 2 shows that User B 204 has been selected and is linked to User G 208 and User Z 210. In one embodiment, only the members that are within the current user's social circle(s) and that are linked to the selected member 204 are displayed. However, this embodiment is not required. The user is then able to select one or more of the other users as indicated by the dashed/dotted box 212. The interactive environment Interface 112 then displays information associated with the selected user 208. For example, FIG. 2 shows that a picture 214 of the selected user 208 is displayed. Other user details 216 such as interests, likes/dislikes, or any other information can be displayed.

In one embodiment, a user can select the information that other members can see. Various policies can be configured that allows different users to see different information. For example, members within a user's social circle(s) may not be able to see more information than a user who is not in a social circle of another user.

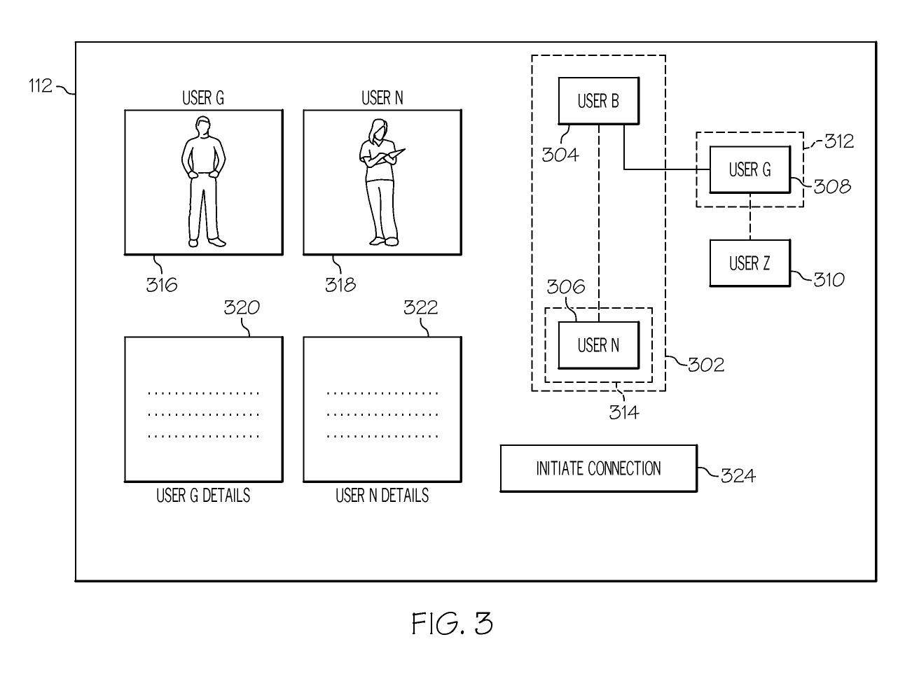

If the user is interested in the selected user 208 then the user can send a connection request to this user via selecting a widget 218 or by any other mechanism. The selected user 208 is then notified of the connection request and can then accept, deny, request additional information, etc. the connection request. FIG. 3 shows another embodiment, where a user initiates a connection request on behalf of two or more users. For example, FIG. 3 shows one example of an interactive environment Interface 112 that displays the user's social circle 302 and its members 304, 306. The user is able to select one or more of the members 304, 306 and be presented with a list of users that are linked to the selected member 304. For example, FIG. 3 shows that User B 304 has been selected and is linked to User G 308 and User Z 310.

The user is then able to select one or more of the other users as indicated by the dashed/dotted box 312. FIG. 3 also shows that the user has selected one of its social circle members User N 306 as indicated by the dashed/dotted box 314. The interactive environment Interface 112 then displays information associated with the selected users 306, 308. For example, FIG. 3 shows that pictures 316, 318 of the selected users 306, 308 are displayed. Other user details 320, 322 such as interests, likes/dislikes, or any other information can be displayed for each of the selected users 306, 308. If the user believes that these two users 306, 308 would be a good match or should get to know each other then the user can initiate a connection request on behalf of the users 306, 308 via selecting a widget 324 or by any other mechanism. The selected users 306, 308 are then notified of the connection request and can then accept, deny, request additional information, etc. the connection request. The users 306, 308 can also be notified of the user who initiated the connection request. The users 306, 308 can also be displayed information and pictures of the other user in the connection request.

As can be seen from the above discussion, users are able to connect with other members linked to a mutual peer. Also, a user is able to initiate a connection with two or more members. In other words, the interactive environment 110 allows users to introduce their single friends to the single friends of others. Users are able to join the interactive environment 100, in one embodiment, free or charge. The users are able to create a circle of friends to network with; send invitations to friends, family, and colleagues; search through emails; link to schools and organizations; and the like. Users can search through their own databases associated with their social circle. Searches performed by users for people can be based on the user's own parameters such as age, location, etc. The interactive environment 110 also offers matching services available within a user's social circles. These matching circles can also connect a user with other circles that the user is not linked with. The interactive environment 100 can then show the user how the user is connected with other users through six degrees of connection. Users can also search through other networks/circles with permission.

The interactive environment 110 also allows a user to critique a date. For example, a user can assign various importance, ratings, or weights to pertinent information regarding a date or the date as a whole. This rating information can either be made private (where only the user can see the rating), semi-private (where a select group of other users such as selected friends or selected circles can see the rating information, or public (where any user of the interactive environment is able to see the rating information). In an embodiment where the rating information is made public, users can review the rating information to make a more informed choice about linking two users together; before a user accepts a request to be linked to someone; before meeting a person; and/or the like. The rating information can also be used to automatically order profiles of users. For examples, if a user is looking at his/her friend's friends, the friends can be organized based on their date ratings.

Social Network Progression Graph

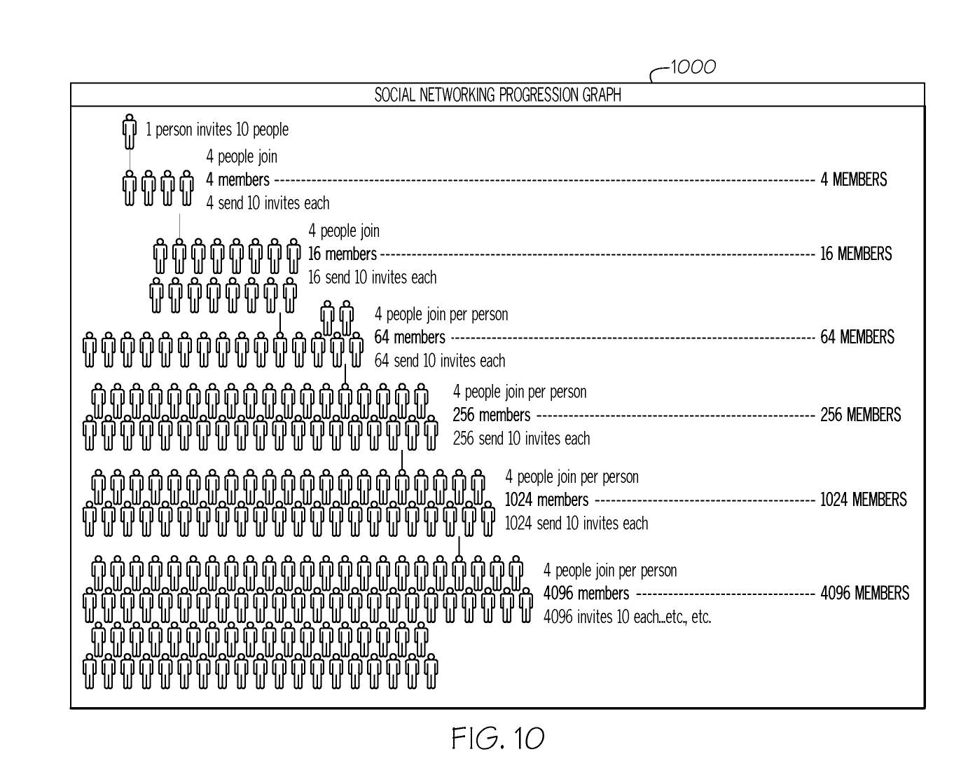

FIG. 10 is a graph illustrating a progression graph 1000 for the interactive environment 110. As can be seen from FIG. 10 as a member of the interactive environment 110 invites a given number of people to join, those people join the environment 110 and then invite additional people to join. As more people join and invite others to become members of the environment 110 the number of members progressively increases as shown by the graph 1000.

Operation Flow Diagrams

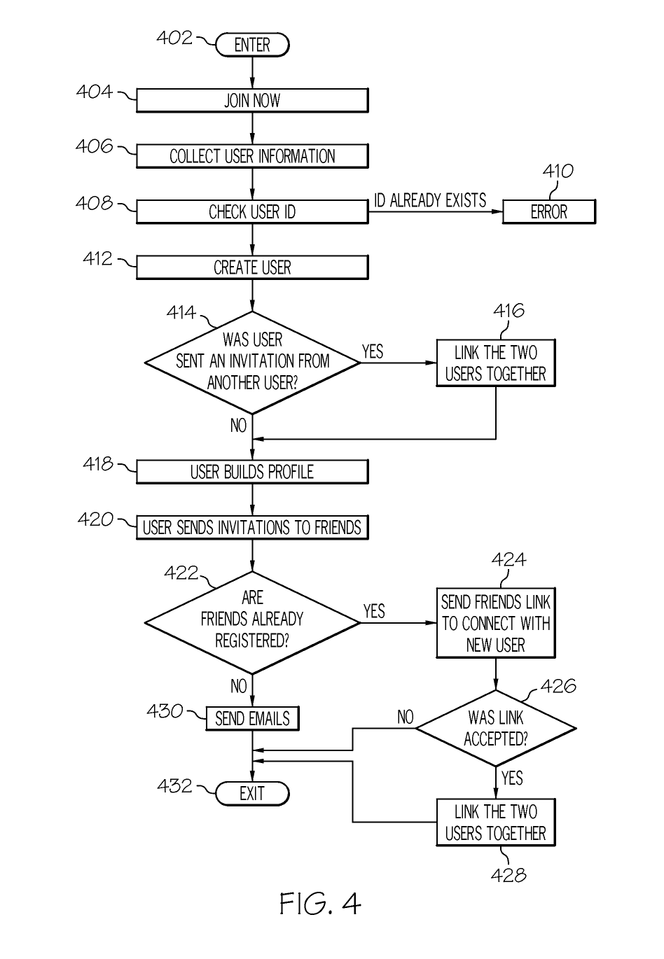

FIG. 4 is an operational flow diagram illustrating one process of a user joining the interactive environment 110. The operational flow diagram of FIG. 4 beings at step 402 and flows directly to step 404. The interactive environment manager 116, at step 402, determines that user is requesting to join the interactive environment 110. The interactive environment manager 116, at step 406, collects user information. The interactive environment manager 116, at step 408, checks if a desired user ID is already in use. If the result of this determination is positive, the interactive environment manager 116, at step 410, returns an error to the user. If the result of this determination is positive, the interactive environment manager 116, at step 412, creates the user profile associated with the user.

The interactive environment manager 116, at step 414, determines if the user was sent an invitation from another member of the interactive environment 110. If the result of this determination is positive, the interactive environment manager 116, at step 416, links the two users together and the flow continues to step 418. If the result of this determination is negative, the interactive environment manager 116, at step 418, receives additional profile information from the user. The interactive environment manager 116, at step 420, determines that the user wants to send invitations to people to join the interactive environment 110.

The interactive environment manager 116, at step 422, determines if any of the people that the user wants to send an invitation to are already a member of the environment 110. If they are, then the interactive environment manager 116, at step 424, sends a link to these people so that they can be connected with the new user. These individuals have the option of rejecting or accepting the link. If a person does not accept the link, at step 426, the flow ends at step 432. If the person does accept the link, then the interactive environment manager 116, at step 428, links the two users together. If however, a person is not already a member of the environment 110, then the interactive environment manager 116, at step 430, sends an email with an invitation to join the environment 110. The control flow then ends at step 432.

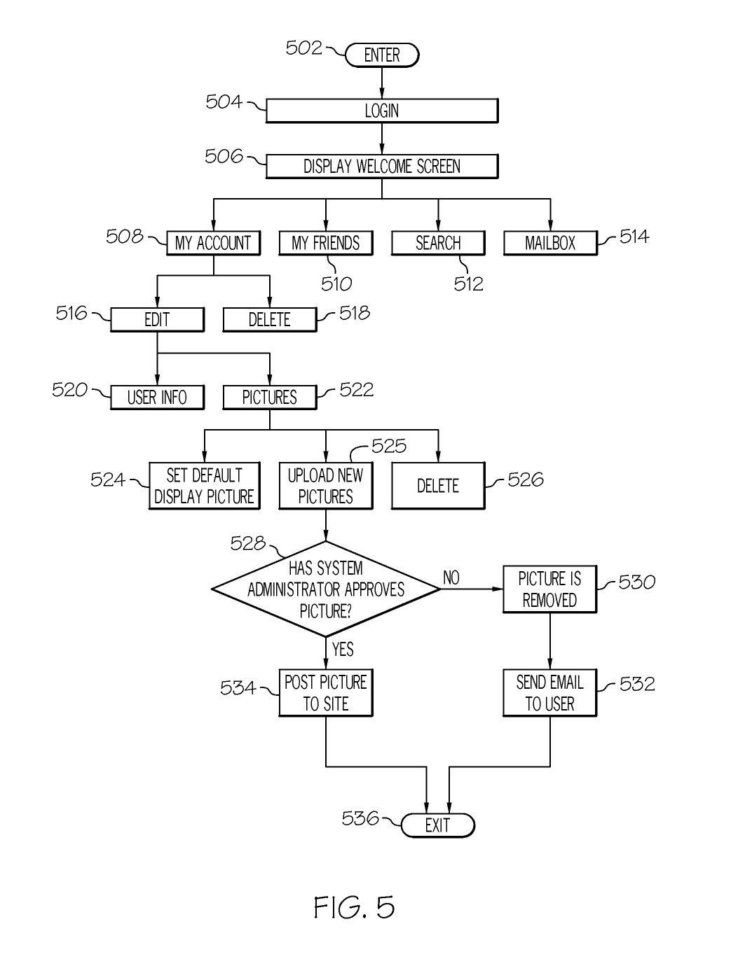

FIG. 5 is an operational flow diagram illustrating one process of a user logging into the interactive environment and updating information. The operational flow diagram of FIG. 5 beings at step 502 and flows directly to step 504. A user, at step 504, logs into the environment 110. The interactive environment manager 116, at step 506, displays a welcome screen to the user. The interactive environment manager 116, at steps 508-514, displays various options to the user such as my account option, a my friends option, a search option, and a mailbox option.

The user, at steps 516-522, is able to edit/delete user information and/or pictures. For example, a user at steps 524-526, can set a default display picture, upload new pictures, and/or delete pictures. If a user uploads a new picture, a system administrator, at step 528, determines whether or not the picture is to be approved. If the picture is not approved then the picture is removed, at step 530, and an email is sent to the user, at step 532, notifying the user that the picture was not approved. The control flow then exits at step 536. If the picture is approved then the picture is posted to the interactive environment 100, at step 534. The control flow then exits at step 536.

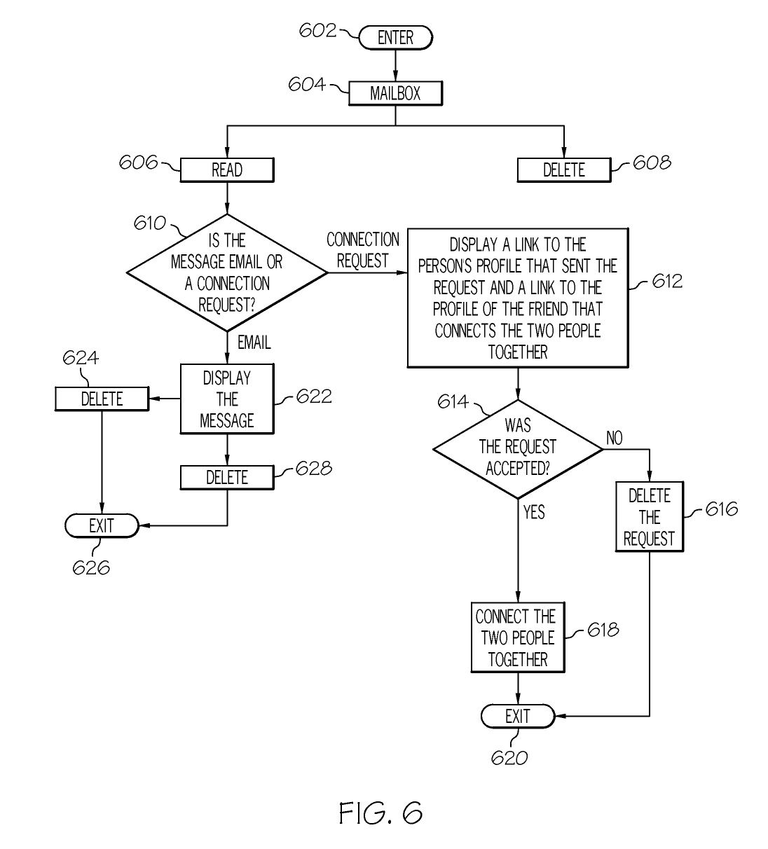

FIG. 6 is an operational flow diagram showing one process of displaying messages and connection requests to a user. The operational flow diagram of FIG. 6 beings at step 602 and flows directly to step 604. The user, at step 604 selects the mailbox option discussed above. The user, at steps 606-608, can read, delete, and/or create messages. If the user selects to read a message, the interactive environment manager 116, at step 610, determines if the message is mail or a connection request. If the message is a connection request, the interactive environment manager 116, at step 612, displays a link to the person's profile that sent the request and a link to the profile of the friend that connected the user with the other user.

The interactive environment manager 116, at step 614, determines if the user accepts the connection request. If the user did not accept the connection request, the interactive environment manager 116, at step 616, deletes the connection request and the control flow exits at step 620. If the user does accept the connection request, the interactive environment manager 116, at step 618, connects the two users together. The control flow then exits at step 620. If the message is determined to be mail, the interactive environment manager 116, at step 622, displays the message. The user, at step 624, can then delete the message, and the control flow exits at step 626. The user, at step 628, can also reply to the message, and the control flow then exits at step 626.

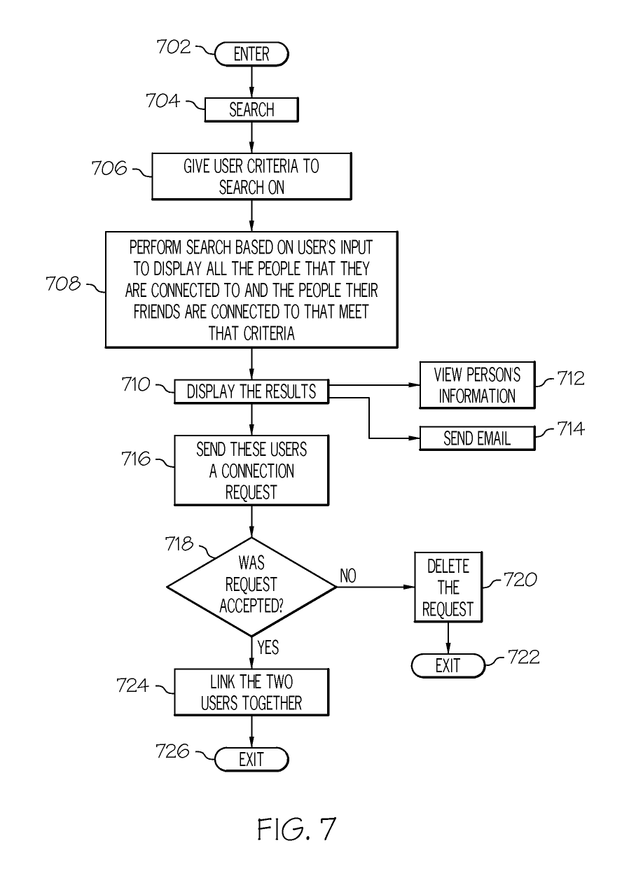

FIG. 7 is an operational flow diagram illustrating one process of a user performing a search within the interactive environment 110. The operational flow diagram of FIG. 7 beings at step 702 and flows directly to step 704. The interactive environment manager 116, at step 704, presents the use with various criteria to search on. The interactive environment manager 116, at step 706, performs a search based on the user's input. In one example, the interactive environment manager 116 displays, at step 710, all of the people that the user is connected with and the people that the user's friends are connected with based on the user's search criteria.

The user, at step 712, can view the information associated with the people returned in the search results. The user, at step 714, can also send an email to one or more of these individuals. The user, at step 716, can also send a connection request to one or more of these individuals as well. If the user sends a connection request, the interactive environment manager 116, at step 718, determines of the connection request was accepted by the recipient. If the recipient does not accept the connection request, the interactive environment manager 116, at step 720, deletes the request and the control flow exits at step 722. If the recipient does accept the connection request, the interactive environment manager 116, at step 724 links the two users together and the control flow exits at step 726.

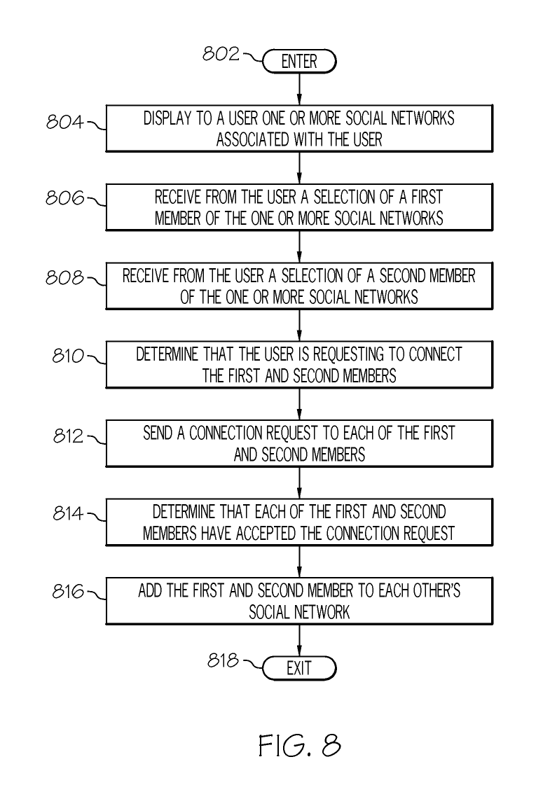

FIG. 8 is an operational flow diagram illustrating one process of a user connecting two friends together using an interactive environment according to one embodiment of the present invention. The operational flow diagram of FIG. 8 begins at step 802 and flows directly to step 804. The interactive environment manager 116, at step 804, displays to a user one or more social networks associated with the user. The interactive environment manager 116, at step 806, receives from the user a selection of a first member of the one or more social networks. The interactive environment manager 116, at step 808, receives a selection of at least a second member of the one or more social networks.

The interactive environment manager 116, at step 810, determines that the user is requesting to connect the first and second members. The interactive environment manager 116, at step 812, sends, in response to the determining, a connection request each of the first and second members. The interactive environment manager 116, at step 814, determines that each of the first and second members has accepted the connection request. The interactive environment manager 116, at step 816, in response to determining that each of the first and second members has accepted the connection request, adds the first and second members to each other's social network(s). Also, if this is the first time either one of the users have been linked to another user, a new social circle is created that maintains a list of who the user has been linked to, as discussed above. The control flow then exits at step 818.

As can be seen above, various embodiments of the present invention distinguish over prior art systems, such as social networking sites, such as FaceBook.com (FB). For example, on FB a user can see friends and befriend someone by sending an invitation to connect. However, the user cannot see any information about a friend's friend. A user, in one or more embodiments of the present invention, on the other hand, can view information about a friend's friend. Specifically, in one or more embodiments, a user can view a friend's friend's (and so on) entire profile and connect to them.

Furthermore, the various embodiments of the present comprise a main focus not on keeping in touch with friends, but on finding a user's perfect someone. Therefore, any type of user search operation, in one or more embodiments, is focused on a user's social circles and the connections. Stated differently, a user, in these embodiments, does not search the entire site randomly, but searches his/her social circles/connections.

Additionally, one or more embodiments of the present invention comprise an area where friends can post information about their friends to help them get a date. The user whose friends are posting information on is able to review this information prior to displaying the information to others. For example, a user can write about specific friend, but the specific friend gets to approve the writing before the writing goes online.

Information Processing System

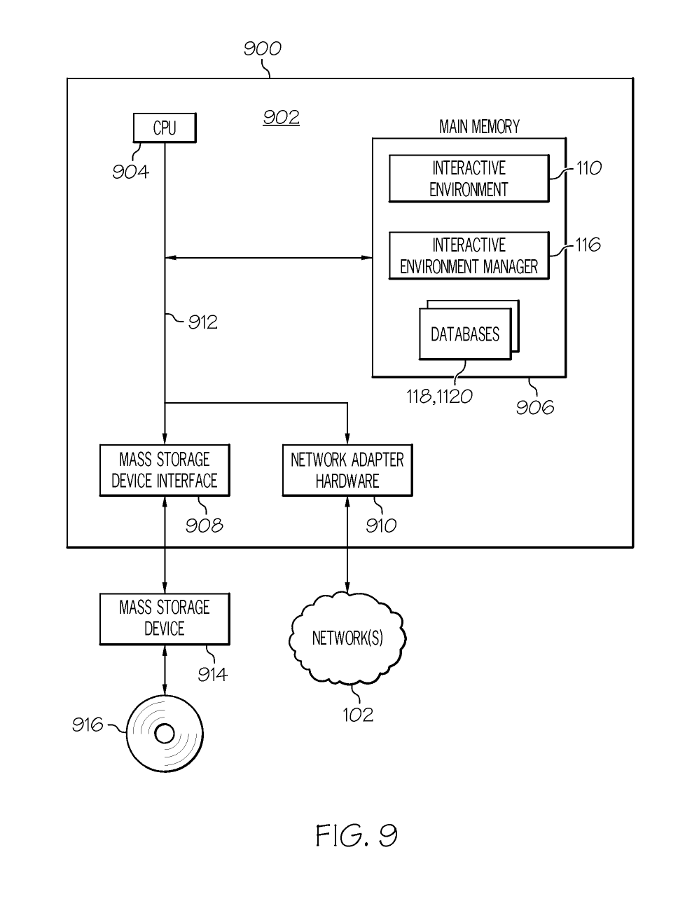

FIG. 9 is a block diagram illustrating a more detailed view of an information processing system 900 that can be utilized in the environment 100 and/or as the information processing system 108 discussed above with respect to FIG. 1. The information processing system 900 is based upon a suitably configured processing system adapted to implement the exemplary embodiment of the present invention. Similarly, any suitably configured processing system can be used as the information processing system 900 by embodiments of the present invention such as an information processing system residing in the computing environment of FIG. 1, a personal computer, workstation, or the like.

The information processing system 900 includes a computer 902. The computer 902 has a processor(s) 904 that is connected to a main memory 906, mass storage interface 908, and network adapter hardware 910. A system bus 912 interconnects these system components. The mass storage interface 908 is used to connect mass storage devices, such as mass storage device 914, to the information processing system 900. One specific type of data storage device is an optical drive such as a CD/DVD drive, which may be used to store data to and read data from a computer readable medium or storage product such as (but not limited to) a CD/DVD 916. Another type of data storage device is a data storage device configured to support, for example, NTFS type file system operations.

The main memory 906, in one embodiment, comprises the interactive environment 110, the interactive environment manager 116, and the various databases 118, 120 discussed above. Although illustrated as concurrently resident in the main memory 906, it is clear that respective components of the main memory 906 are not required to be completely resident in the main memory 906 at all times or even at the same time. In one embodiment, the information processing system 900 utilizes conventional virtual addressing mechanisms to allow programs to behave as if they have access to a large, single storage entity, referred to herein as a computer system memory, instead of access to multiple, smaller storage entities such as the main memory 906 and data storage device 914. Note that the term “computer system memory” is used herein to generically refer to the entire virtual memory of the information processing system 108.

Although only one CPU 904 is illustrated for computer 902, computer systems with multiple CPUs can be used equally effectively. Embodiments of the present invention further incorporate interfaces that each includes separate, fully programmed microprocessors that are used to off-load processing from the CPU 904. An operating system (not shown) included in the main memory is a suitable multitasking operating system such as the Linux, UNIX, Windows XP, and Windows Server operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 900. The network adapter hardware 910 is used to provide an interface to a network 102. Embodiments of the present invention are able to be adapted to work with any data communications connections including present day analog and/or digital techniques or via a future networking mechanism.

Although the exemplary embodiments of the present invention are described in the context of a fully functional computer system, those of ordinary skill in the art will appreciate that various embodiments are capable of being distributed as a program product via CD or DVD, e.g. CD 916, CD ROM, or other form of recordable media, or via any type of electronic transmission mechanism.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for operating a matching service, the method comprising:
displaying a first social network associated with a user of an interactive environment, wherein the first social network comprises one or more members of the interactive environment that are linked to the user;
receiving a first selection by the user of at least a first member in the first social network;
displaying, in response to receiving the first selection, to the user at least a second member in a second social network that is associated with the first member and is detached from the user in the interactive environment;
receiving a second selection by the user of the second member;
sending, in response to receiving the second selection of the second member, a connection request to the second member on behalf of the user; and
adding the second member to the first social network in response to the second member accepting the connection request.

2. The method of claim 1, further comprising:
generating, in response to the second member accepting the connection request, a third social network, wherein the third social network is associated with the user and the second member, and wherein the third social network links the user and the second member together in the interactive environment.

3. The method of claim 2, wherein the third social network further comprises members of the second social network that have been linked to the user through at least one member in the first social network.

4. The method of claim 1, further comprising:
receiving, from the user, a rating associated with the second member; and
adding the rating to a profile of the second member in the interactive environment.

5. The method of claim 1, further comprising:
receiving, from the user, an input that verifies a set of information in a profile associated with one of the one or more members in the first social network; and
indicating in the profile that the set of information has been verified.

6. A method, with an information processing system, for operating a matching service, the method comprising:
displaying a first social network and a second social network associated with a user of an interactive environment, wherein the first and second social networks comprise one or more members of the interactive environment that are linked to the user;
receiving a selection by the user of at least a first member in the first social network and at least a second member in the second social network, wherein the first member and the second member are detached from each other within the interactive environment; and
sending, in response to receiving the selection of the first member and the second member, a connection request to the first member and the second member for linking the first member and the second member together.

7. The method of claim 6, further comprising:
determining that the first member and second member have accepted the connection request; and
linking, in response to the determining, the first member and the second member together in the interactive environment.

8. The method of claim 6, further comprising:
determining that the first member and second member have accepted the connection request; and
generating, in response to the determining, a third social network;
associating the third social network with the first member;
linking the second member to the first member in the third social network.

9. The method of claim 6, further comprising:
determining that the first member and second member have accepted the connection request; and
generating, in response to the determining, a third social network;
associating the third social network with the second member;
linking the first member to the second member in the third social network.

10. The method of claim 8, wherein the third social network associated with the first member further comprises members of the second social network that have been linked to the user by the user.

11. The method of claim 8, wherein the third social network associated with the second member further comprises members of the first social network that have been linked to the user by the user.

12. The method of claim 6, further comprising:
receiving, from the first member, a rating associated with the second member; and
adding the rating to a profile of the second member in the interactive environment.

13. The method of claim 6, further comprising:
receiving, from the second member, a rating associated with the first member; and
adding the rating to a profile of the first member in the interactive environment.

14. The method of claim 6, further comprising:
receiving, from the user, at least one input that verifies at least one set of information in at least one profile associated with at least one of the first member and the at least one second member; and
indicating in the at least one profile that the set of information has been verified.

15. An information processing system for operating a matching service, the information processing system comprising:
a memory;
a processor communicatively coupled to the memory; and
an interactive environment communicatively coupled to the memory and the processor, wherein the interactive environment performs:
receiving, from at least one member in a first social network, a rating associated with at least one member in a second social network, wherein the rating reflects a quality of an interaction between the at least one member in a first social network and the at least one member in the second social network;
displaying the first social network and the second social network to the user of the interactive environment, wherein the first and second social networks comprise one or more members of the interactive environment that are linked to the user, wherein the displaying comprises:
organizing at least the one or more members in the second social network based on the rating associated therewith;
displaying the rating associated with each of the one or more members in the second social network to the user;
receiving an indication from the user that a set of information associated with at least one member in the one or more members is authentic;
updating a profile associated with the at least one member to indicate that the set of information has been verified by the user;
receiving a selection by the user of at least a first member in the first social network and at least a second member in the second social network, wherein the first member and the second member are detached from each other in the interactive environment, the selection of the second member in the second social network being based on the rating associated therewith; and
sending, in response to receiving the selection of the first member and the second member, a connection request to the first member and the second member for linking the first member and the second member together.

16. The information processing system of claim 15, wherein the method further comprises:
determining that the first member and second member have accepted the connection request; and
linking, in response to the determining, the first member and the second member together in the interactive environment.

17. The information processing system of claim 15, wherein the method further comprises:
determining that the first member and second member have accepted the connection request; and
generating, in response to the determining, a third social network;
associating the third social network with the second member;
linking the first member to the second member in the third social network.

18. The information processing system of claim 17, wherein the third social network associated with the first member further comprises members of the second social network that have been linked to the user by the user.

19. The information processing system of claim 15, wherein the method further comprises:
receiving, from at least one of the first member and the second member, a rating associated with at least one of the second member and first member, respectively; and
adding the rating to at least one profile of the at least one second member and first member, respectively, in the interactive environment.

20. The information processing system of claim 15, wherein the method further comprises:
receiving, from the user, at least one input that verifies at least one set of information in at least one profile associated with at least one of the first member and the at least one second member; and
indicating in the at least one profile that the set of information has been verified.
